(19) United States
(12) Patent Application Publication
(10) Pub. No.: US 2019/0251429 A1
(43) Pub. Date: Aug. 15, 2019

(54) CONVOLUTION OPERATION DEVICE AND METHOD OF SCALING CONVOLUTION INPUT FOR CONVOLUTION NEURAL NETWORK

(71) Applicant: Kneron, Inc., San Diego, CA (US)

(72) Inventors: Li DU, La Jolla, CA (US); Yuan DU, Los Angeles, CA (US); Jun-Jie SU, San Diego, CA (US); Ming-Zhe JIANG, San Diego, CA (US)

(21) Appl. No.: 15/894,177

(22) Filed: Feb. 12, 2018

(51) Int. Cl. G06N 3/08; G06N 3/04

(52) U.S. Cl. CPC G06N 3/08; G06N 3/04

(57) ABSTRACT

A convolution operation device includes a convolution operation module, a memory, a scale control module and a scaling unit. The convolution operation module outputs a plurality of convolution operation results containing fractional parts. The memory is coupled to the convolution operation module for receiving and storing the convolution operation results containing the fractional parts, and outputs a plurality of convolution operation input values containing fractional parts. The scale control module is coupled to the convolution operation module and generates a scaling signal according to a total scale of the convolution operation results containing the fractional parts. The scaling unit is coupled to the memory, the scale control module, and the convolution operation module, adjusts the scale of the convolution operation input values containing the fractional parts according to the scaling signal, and outputs the adjusted convolution operation input values containing the fractional parts to the convolution operation module.

### BACKGROUND

### Technology Field

The present disclosure relates to a convolution operation device and, in particular, to a convolution operation device and method that can scale the convolution input values.

### Description of Related Art

Deep learning is an important technology for developing artificial intelligence (AI). In the recent years, the convolutional neural network (CNN) is developed and applied in the identification of the deep learning field. Compared with other deep learning architectures, especially in the mode classification field such as picture and voice identifications, the convolutional neural network can directly process the original pictures or data without the complex preprocessing. Thus, it becomes more popular and has a better identification result.

However, the convolution operation usually consumes a lot of performance. In the convolutional neural network application, especially for the convolution operation of fractional parts, the truncation error or ceiling error may occur after the calculations of multiple convolution layers. Therefore, it is desired to provide a convolution operation device that can reduce the truncation error or ceiling error.

### SUMMARY

In view of the foregoing, the present disclosure is to provide a convolution operation device and method that can reduce the truncation error or ceiling error.

A convolution operation device includes a convolution operation module, a memory, a scale control module, and a scaling unit. The convolution operation module outputs a plurality of convolution operation results containing fractional parts. The memory is coupled to the convolution operation module for receiving and storing the convolution operation results containing the fractional parts, and outputting a plurality of convolution operation input values containing fractional parts. The scale control module is coupled to the convolution operation module and generates a scaling signal according to a total scale of the convolution operation results containing the fractional parts. The scaling unit is coupled to the memory, the scale control module, and the convolution operation module. The scaling unit adjusts a scale of the convolution operation input values containing the fractional parts according to the scaling signal, and outputs the adjusted convolution operation input values containing the fractional parts to the convolution operation module.

In one embodiment, the convolution operation results containing the fractional parts are operation results of an (N−1)^{th} layer of a convolution neural network, and the convolution operation input values containing the fractional parts are operation inputs of an N^{th} layer of the convolution neural network. Herein, N is a natural number greater than 1.

In one embodiment, the convolution operation results containing the fractional parts of a final layer of the convolution neural network stored in the memory are directly outputted without processing a reverse scaling.

In one embodiment, the convolution operation results containing the fractional parts of a final layer of the convolution neural network stored in the memory are processed with a reverse scaling and then outputted.

In one embodiment, the scale control module includes a detector and an estimator. The detector is coupled to the convolution operation module for detecting the total scale of the convolution operation results containing the fractional parts. The estimator is coupled to the detector for receiving at least a convolution operation coefficient and estimating a possible convolution operation scale according to the total scale of the convolution operation results containing the fractional parts and the convolution operation coefficient so as to generate the scaling signal according to the possible convolution operation scale.

In one embodiment, when the possible convolution operation scale is relative small, the scaling signal control the scaling unit to scale up the convolution operation input values containing the fractional parts.

In one embodiment, when the possible convolution operation scale is relative large, the scaling signal control the scaling unit to scale down the convolution operation input values containing the fractional parts.

In one embodiment, the detector includes a counting unit, a first integration unit, an averaging unit, a squaring unit, a second integration unit and a variation unit. The counting unit accumulates amounts of the convolution operation results containing the fractional parts for outputting a total amount. The first integration unit accumulates values of the convolution operation results containing the fractional parts for outputting a total value. The averaging unit is coupled to the counting unit and the first integration unit and divides the total value by the total amount to generate an average value. The squaring unit squares the values of the convolution operation results containing the fractional parts for outputting a plurality of squared values. The second integration unit is coupled to the squaring unit and accumulates the squared values to generate a total squared value. The variation unit is coupled to the counting unit and the second integration unit and divides the total squared value by the total amount to generate a variation value. The average value and the variation value represent the total scale of the convolution operation results containing the fractional parts.

In one embodiment, the estimator estimates the possible convolution operation scale according to Gaussian distribution.

In one embodiment, the convolution operation device is a chip, and the memory is a cache or a register inside the chip.

A scaling method of convolution inputs of a convolution neural network includes: outputting a plurality of convolution operation results containing fractional parts from a convolution operation module; generating a scaling signal according to a total scale of the convolution operation results containing the fractional parts; outputting a plurality of convolution operation input values containing fractional parts from a memory; adjusting a scale of the convolution operation input values containing the fractional parts according to the scaling signal; and outputting the adjusted convolution operation input values containing the fractional parts to the convolution operation module.

In one embodiment, the convolution operation results containing the fractional parts are operation results of an (N−1)^{th} layer of a convolution neural network, and the convolution operation input values containing the fractional parts are operation inputs of an N^{th} layer of the convolution neural network. Herein, N is a natural number greater than 1.

In one embodiment, the convolution operation results containing the fractional parts of a final layer of the convolution neural network stored in the memory are directly outputted without processing a reverse scaling.

In one embodiment, the convolution operation results containing the fractional parts of a final layer of the convolution neural network stored in the memory are processed with a reverse scaling and then outputted.

In one embodiment, the step of generating the scaling signal includes: detecting the total scale of the convolution operation results containing the fractional parts; estimating a possible convolution operation scale according to the total scale of the convolution operation results containing the fractional parts and a convolution operation coefficient; and generating the scaling signal according to the possible convolution operation scale.

In one embodiment, when the possible convolution operation scale is relative small, the scaling signal control the scaling unit to scale up the convolution operation input values containing the fractional parts.

In one embodiment, when the possible convolution operation scale is relative large, the scaling signal control the scaling unit to scale down the convolution operation input values containing the fractional parts.

In one embodiment, the step of detecting the total scale includes: accumulating amounts of the convolution operation results containing the fractional parts for outputting a total amount; accumulating values of the convolution operation results containing the fractional parts for outputting a total value; dividing the total value by the total amount to generate an average value; squaring the values of the convolution operation results containing the fractional parts for outputting a plurality of squared values; accumulating the squared values to generate a total squared value; and dividing the total squared value by the total amount to generate a variation value. The average value and the variation value represent the total scale of the convolution operation results containing the fractional parts.

In one embodiment, the estimating step is to estimate the possible convolution operation scale according to Gaussian distribution.

As mentioned above, the convolution operation device and the scaling method of the convolution inputs of the convolution neural network of this disclosure can adjust the convolution operation input values containing fractional parts according to the total scale of the convolution operation results containing fractional parts. Accordingly, during the convolution operation, the numeric is not always in the fixed point format. In this disclosure, the possible range of the subsequent or next convolution operation results is estimated followed by dynamically scaling up or down the scale of the convolution operation input values and adjusting the position of the decimal point of the convolution operation input values. This configuration can prevent the truncation error or ceiling error in the convolution operation.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a block diagram of a convolution operation device according to an embodiment of the disclosure;

FIG. 2 is a schematic diagram of a convolution neural network;

FIGS. 3A and 3B are schematic diagrams showing the convolution operations of one layer in the convolution neural network;

FIG. 4A is a schematic diagram showing the step for scaling down the convolution operation input values containing fractional parts;

FIG. 4B is a schematic diagram showing the step for scaling up the convolution operation input values containing fractional parts;

FIGS. 5A and 5B are schematic diagrams showing the scaling processes in the convolution neural network;

FIGS. 6A and 6B are block diagrams of convolution operation devices according to another embodiment of the disclosure; and

FIG. 7 is a block diagram of a detector shown in FIG. 6A or 6B.

### DETAILED DESCRIPTION OF THE DISCLOSURE

The present disclosure will be apparent from the following detailed description, which proceeds with reference to the accompanying drawings, wherein the same references relate to the same elements.

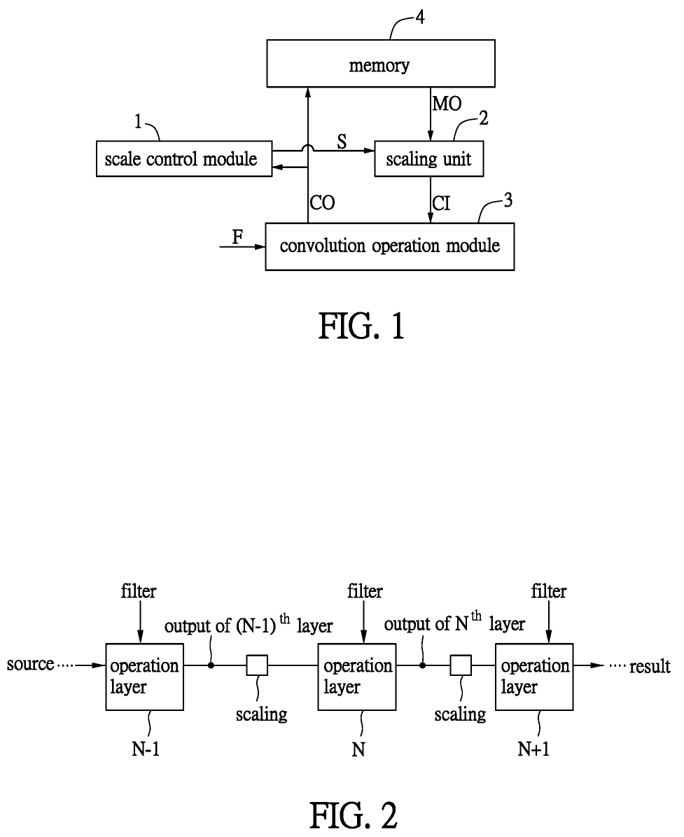

FIG. 1 is a block diagram of a convolution operation device according to an embodiment of the disclosure. Referring to FIG. 1, the convolution operation device includes a convolution operation module 3, a memory 4, a scale control module 1, and a scaling unit 2. The convolution operation device can be applied in the application of convolution neural network (CNN).

The memory 4 stores the convolution operation input values MO (for the following convolution operations) and the convolution operation results CO. The convolution operation result CO can be an intermediate result or a final result. The input values or results can be, for example, image data, video data, audio data, statistics data, or the data of any layer of the convolutional neural network. The image data may contain the pixel data. The video data may contain the pixel data or movement vectors of the frames of the video, or the audio data of the video. The data of any layer of the convolutional neural network are usually 2D array data. The image data are usually 2D array pixel data. In addition, the memory 4 may include multiple layers of storage structures for individually storing the data to be processed and the processed data. In other words, the memory 4 can be functioned as a cache of the convolution operation device.

The convolution operation input values MO for following convolution operations can be stored in other places, such as another memory or an external memory outside the convolution operation device. For example, the external memory or another memory can be optionally a DRAM (dynamic random access memory) or other kinds of memories. When the convolution operation device perform the convolution operation, these data can be totally or partially loaded to the memory 4 from the external memory or another memory, and then the convolution operation module 3 can access these data from the memory 4 for performing the following convolution operation.

The convolution operation module 3 includes one or more convolution units. Each convolution unit executes a convolution operation based on a filter and a plurality of current convolution operation input values CI for generating convolution operation results CO. The generated convolution operation results CO can be outputted to and stored in the memory 4. One convolution unit can execute an m×m convolution operation. In more detailed, the convolution operation input values CI include m values, and the filter F includes m filter coefficients. Each convolution operation input value CI is multiplied with one corresponding filter coefficient, and the total multiplying results are added to obtain the convolution operation result of the convolution unit.

In the application of convolution neural network, the convolution operation results CO are stored in the memory 4. Accordingly, when the convolution operation module 3 performs the convolution operation for next convolution layer, the data can be rapidly retrieved from the memory 4 as the inputs of the convolution operation. The filter F includes a plurality of filter coefficients, and the convolution operation module 3 can directly retrieve the filter coefficients from external memory by direct memory access (DMA).

In general, each of the convolution operation input values, filter coefficients and the convolution operation results is a numeric containing a fractional part. As shown in FIG. 1, the convolution operation module 3 outputs a plurality of convolution operation results CO containing fractional parts. The memory 4 is coupled to the convolution operation module 3 for receiving and storing the convolution operation results CO containing the fractional parts. The memory 4 further outputs a plurality of convolution operation input values MO containing fractional parts for performing convolution operations. The scale control module 1 is coupled to the convolution operation module 3 and generates a scaling signal S according to a total scale of the convolution operation results CO containing the fractional parts. The scaling unit 2 is coupled to the memory 4, the scale control module 1, and the convolution operation module 3. The scaling unit 2 adjusts a scale of the convolution operation input values MO containing the fractional parts according to the scaling signal S, and outputs the adjusted convolution operation input values CI containing the fractional parts to the convolution operation module 3.

Each of the convolution operation input values, the filter coefficients and convolution operation results includes an integer part and a fractional part, and the widths of these data are the same. Thus, the multiplication in the convolution operation can easily generate truncation error or ceiling error. In order to prevent these errors, the numeric is not always in the fixed point format during the convolution operation. In this disclosure, the data format of the convolution operation input values is dynamically adjusted (e.g. by scaling up or down). Accordingly, the width of the convolution operation input values is kept the same, but the position of the decimal point of the convolution operation input values is shifted right or left. In other words, in each convolution operation input value, the bits of the integer part and the fractional part can be dynamically adjusted, thereby reducing the computation error and still keeping the same bit width of the convolution operation results.

The total scale of the convolution operation results CO containing the fractional part can be represented by the average value and standard deviation thereof. For example, if the convolution operation results CO containing the fractional parts includes m values, the average value and standard deviation of these m values are obtained to represent the total scale. Assuming the m values are modelled as Gaussian distribution, the average value and standard deviation can represent the distribution status of these m values. The estimator can estimate the possible convolution operation scale based on the Gaussian distribution. Since the convolution operation results of the previous layer are the inputs of the current layer, the range of the convolution operation results of the current layer can be estimated based on the pre-known convolution operation results of the previous layer. Accordingly, it is possible to make the effective bit width of the convolution operation results of the current layer be the same as or approach the width of the filter coefficients or the width of the convolution operation input values. For example, when the width of the filter coefficients or the width of the convolution operation input values is 16 bits, the effective bit width of the convolution operation results of the current layer can be or approach 16 bits.

FIG. 2 is a schematic diagram of a convolution neural network. As shown in FIG. 2, the convolutional neural network has a plurality of operation layers, such as the convolutional layer or the convolution and pooling layers. The output of each operation layer is an intermediate result, which can be functioned as the input of another layer or any consecutive layer. For example, the output of the (N−1)^{th} operation layer is the input of the N^{th} operation layer or any consecutive layer, the output of the N^{th} operation layer is the input of the (N+1)^{th} operation layer or any consecutive layer, and so on. The filters of different layers can be the same or different.

The convolution operation device of FIG. 1 can perform the convolution neural network operation as shown in FIG. 2. In this embodiment, the convolution operation results containing fractional parts are the operation results of the (N−1)^{th} layer of the convolution neural network, and the convolution operation input values containing the fractional parts are operation inputs of the N^{th} layer of the convolution neural network. Herein, N is a natural number greater than 1. For example, the convolution operation module 3 executes the (N−1)^{th} operation layer so as to generate the outputs of the (N−1)^{th} operation layer, which are the convolution operation results CO containing fractional parts outputted to and stored in the memory 4. The scale control module 1 also receives the convolution operation results CO containing fractional parts and generates the scaling signal S accordingly. When the convolution operation module 3 is going to execute the N^{th} operation layer, the outputs of the (N−1)^{th} operation layer stored in the memory 4 are not directly outputted to the convolution operation module 3. In this embodiment, the outputs of the (N−1)^{th} operation layer are the convolution operation input values MO containing fractional parts, which are inputted to the scaling unit 2, and then the scaling unit 2 adjusts the scale of the inputs of the N^{th} layer and outputs the adjusted convolution operation input values CI containing fractional parts to the convolution operation module 3. The consecutive operation layers all have the same process.

In general, the CNN adopts the fixed point format to show the filter coefficients and the intermediate results. In other words, the inputs and outputs of all operation layers all adopt the same fixed point format. The fixed point format includes an integer part and a fractional part. The integer part has j bits, and the fractional part has k bits. For example, the 16-bit fixed point data usually have an 8-bit integer part and an 8-bit fractional part, and the leftmost bit of the integer part may be a sign bit.

However, the bit width of the convolution operation results is greater than the bit width of the filter coefficients or the input values. In order to keep the bit widths of the convolution operation result and the filter coefficient or input value to be the same, a part of the convolution operation result must be truncated. Taking 16-bit data as an example, generally, the convolution operation result is a 32-bit output, including 16-bit integer and 16-bit fraction. To keep the total width to be 16 bits, the 16-bit fraction needs to be truncated to be 8 bits, which results a truncation error, and the 16-bit integer needs to be ceiled to be 8 bits, which results a ceiling error. In this embodiment, the scale of the convolution input values containing fractional parts can be dynamically adjusted, thereby reducing the above computation errors.

Since the convolution neural network usually includes more than one layers, the dynamic scaling procedure between different layers can further minimize the truncation error and the ceiling error after the operations of multiple layers.

In addition, the convolution operation results containing the fractional parts of a final layer of the convolution neural network stored in the memory 4 are processed with a reverse scaling and then outputted. For example, the convolution operation results are outputted to a controller or a device outside the convolution operation device. In one embodiment, the scaling process can cause the shift of the decimal point in the convolution output results. The reverse scaling step is to eliminate the accumulated shift of the decimal point after multiple layers of convolution operations, so that the decimal point of the convolution operation results containing the fractional parts of the final layer can be shifted to a proper position in the current scale. For example, if the accumulated shift after multiple layers of convolution operations is at 6 bits to right, the value of the convolution operation result containing the fractional part of the final layer should be shifted for 6 bits leftwardly. This operation is suitable for the application that focusing on the values of the convolution operation results.

In addition, the convolution operation results containing the fractional parts of a final layer of the convolution neural network stored in the memory 4 are directly outputted without processing a reverse scaling. For example, the convolution operation results are outputted to a controller or a device outside the convolution operation device. In this embodiment, no matter how many the accumulated shift of the decimal point is, the step for shifting the decimal point back is not needed. This operation is suitable for the application that focusing on the ratio of the convolution operation results, which is not focusing on the values of the convolution operation results.

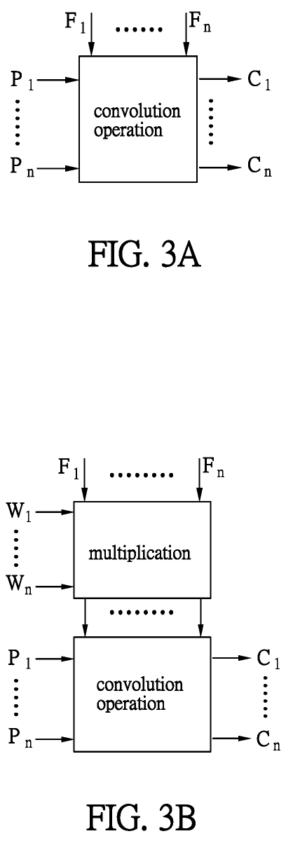

FIGS. 3A and 3B are schematic diagrams showing the convolution operations of one layer in the convolution neural network. As shown in FIG. 3A, in the convolution layer, a plurality of data P1-Pn and a plurality of filter coefficients F1-Fn are provided to execute a convolution operation for generating a plurality of data C1-Cn. The data P1-Pn represent the convolution operation input values CI containing fractional parts, and the data C1-Cn represent the convolution operation results CO containing fractional parts. The filter coefficients F1-Fn can be weighted or not. In the case of FIG. 3A, the filter coefficients F1-Fn are not weighted, so the original filter coefficients F1-Fn are directly provided for the convolution operation. The weighting step is to multiply the original filter coefficients F1-Fn by one or more weight values. In the case of FIG. 3B, the original filter coefficients F1-Fn are multiplied by multiple weight values W1-Wn, and the weighted filter coefficients are then provided for the convolution operation.

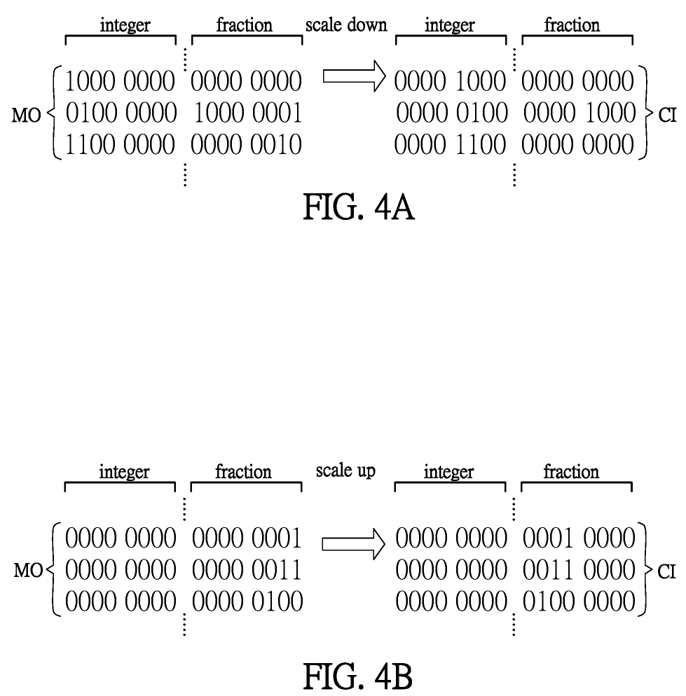

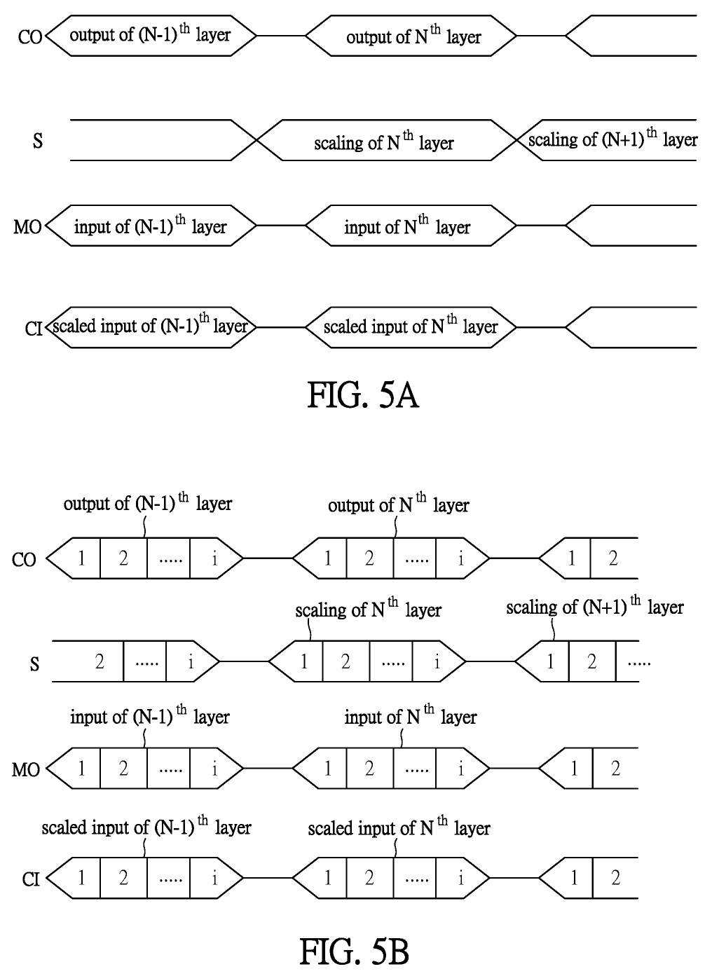

FIG. 4A is a schematic diagram showing the step for scaling down the convolution operation input values containing fractional parts. As shown in FIG. 4A, when the convolution operation scale of the multiplication results of the convolution operation input values MO containing fractional parts is relative large, the scaling signal S can control the scaling unit 2 to scale down the convolution operation input values MO containing fractional parts, and the scale-down input values CI are inputted to the convolution operation module 3. In FIG. 4A, for example, the values have 8-bit integer and 8-bit fraction. When the convolution operation input values MO containing fractional parts and the filter coefficients are large, the generated convolution operation results CO containing fractional parts will become very large. In this case, if the convolution output format only has 8-bit fraction, a serious ceiling error will occur. According to this embodiment, the scale control module 1 can estimate that the convolution operation results will become very large, and thus perform the scale-down step for scaling down the convolution operation input values MO containing fractional parts by certain bit numbers (e.g. shifting m bits rightwardly). Therefore, the disclosure can minimize the ceiling error.

FIG. 4B is a schematic diagram showing the step for scaling up the convolution operation input values containing fractional parts. As shown in FIG. 4B, when the convolution operation scale of the multiplication results of the convolution operation input values MO containing fractional parts is relative small, the scaling signal S can control the scaling unit 2 to scale up the convolution operation input values MO containing fractional parts, and the scale-up input values CI are inputted to the convolution operation module 3. In FIG. 4B, for example, the values have 8-bit integer and 8-bit fraction. When the convolution operation input values MO containing fractional parts and the filter coefficients are small, the generated convolution operation results CO containing fractional parts will become very small. In this case, if the convolution output format only has 8-bit fraction, a serious truncation error will occur. According to this embodiment, the scale control module 1 can estimate that the convolution operation results will become very small, and thus perform the scale-up step for scaling up the convolution operation input values MO containing fractional parts by certain bit numbers (e.g. shifting m bits leftwardly). Therefore, the disclosure can minimize the truncation error.

FIGS. 5A and 5B are schematic diagrams showing the scaling processes in the convolution neural network. As shown in FIG. 5A, the scale control module 1 will evaluate the convolution operation results containing fractional parts of a whole layer for obtaining the possible convolution operation scale of next layer. Accordingly, the scaling signal S for each layer is calculated after generating the convolution operation results containing fractional parts of the whole layer.

As shown in FIG. 5B, the scale control module 1 will evaluate the convolution operation results containing fractional parts of a characteristic block (a part of one operation layer) for obtaining the possible convolution operation scale of this characteristic block in next layer. Accordingly, the scaling signal S for the characteristic block of each layer is calculated after generating the convolution operation results containing fractional parts of the characteristic block. Thus, the scaling signal S can be generated before generating the convolution operation results containing fractional parts of the whole layer. However, the scaling signal corresponding to the characteristic block is transmitted from the scale control module 1 to the scaling unit 2 after finishing the step of generating the convolution operation results containing fractional parts of the whole layer. Thus, the generated scaling signal S corresponding to the characteristic block is temporarily stored in the memory or register inside the scale control module 1, and is then transmitted to the scaling unit 2 at the corresponding clock.

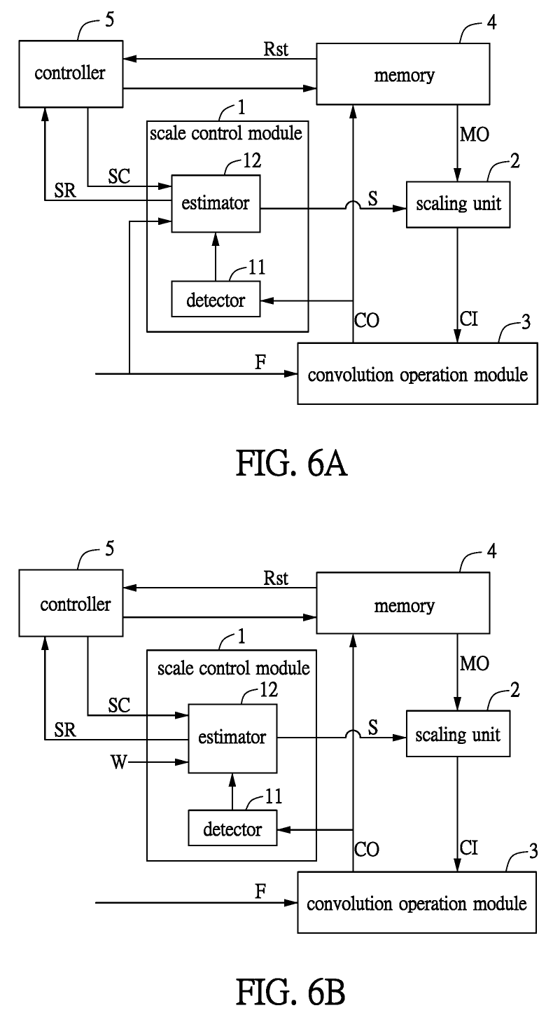

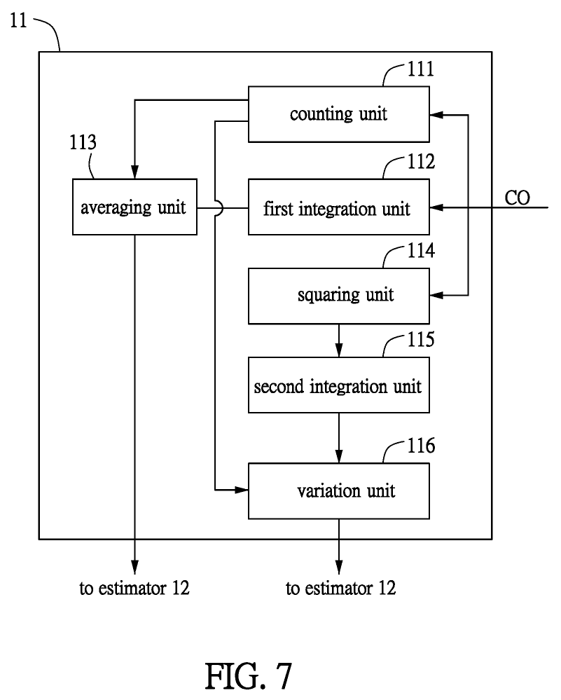

FIG. 6A is a block diagram of a convolution operation device according to another embodiment of the disclosure. As shown in FIG. 6A, the scale control module 1 includes a detector 11 and an estimator 12. The detector 11 is coupled to the convolution operation module 3 for detecting the total scale of the convolution operation results CO containing the fractional parts. The estimator 12 is coupled to the detector 11 for receiving at least one convolution operation coefficient and estimating a possible convolution operation scale according to the total scale of the convolution operation results containing the fractional parts and the convolution operation coefficient so as to generate the scaling signal S according to the possible convolution operation scale. In FIG. 6A, the convolution operation coefficient is the filter coefficient F (e.g. the filter coefficient for next operation layer). The estimator 12 can estimate the filter coefficient F for next layer and the convolution inputs of next layer (the convolution operation results CO containing fractional parts of the current layer) according to the filter coefficient F for next layer and the average value and standard deviation of the convolution operation results CO containing fractional parts of the current layer, and further obtain the possible convolution operation scale accordingly.

In this embodiment, the convolution operation results Rst containing the fractional parts of a final layer of the convolution neural network stored in the memory 4 can be outputted to a controller 5. In this case, the convolution operation results Rst containing the fractional parts are directly outputted without processing a reverse scaling. In addition, the convolution operation results Rst containing the fractional parts can be processed with a reverse scaling and then outputted. For example, the estimator 12 generates a scaling result according to the scaling signal S of each layer, and outputs the scaling result SR to the controller 5. Then, the controller 5 reads the convolution operation results Rst containing the fractional parts to determine whether to perform the reverse scaling or not. The scaling result SR can be a sum of the entire scaling signals S. Alternatively, the estimator 12 may generate one scaling result SR upon generating each scaling signal S. The scaling results SR can transfer the message about the scaling size of each layer to the controller 5. Besides, the controller 5 can output a control signal SC to request the estimator 12 to generate the scaling signal S and scaling result SR by either one of the above modes.

FIG. 6B is a block diagram of a convolution operation device according to another embodiment of the disclosure. Different from FIG. 6A, in the embodiment as shown in FIG. 6B, the convolution operation coefficient is a weighted value W of the filter coefficient F (e.g. the weighted value W of the filter coefficient F for next operation layer). The estimator 12 can estimate the filter coefficient F for next layer and the convolution inputs of next layer (the convolution operation results CO containing fractional parts of the current layer) according to the weighted value W of the filter coefficient F for next layer and the average value and standard deviation of the convolution operation results CO containing fractional parts of the current layer, and further obtain the possible convolution operation scale accordingly.

FIG. 7 is a block diagram of a detector shown in FIG. 6A or 6B. As shown in FIG. 7, the detector 11 includes a counting unit 111, a first integration unit 112, an averaging unit 113, a squaring unit 114, a second integration unit 115, and a variation unit 116. The counting unit 111 accumulates amounts of the convolution operation results CO containing the fractional parts for outputting a total amount. The first integration unit 112 accumulates values of the convolution operation results containing the fractional parts for outputting a total value. The averaging unit 113 is coupled to the counting unit 111 and the first integration unit 112 and divides the total value by the total amount to generate an average value, which is the average value of the convolution operation results CO containing the fractional parts. The squaring unit 114 squares the values of the convolution operation results CO containing the fractional parts for outputting a plurality of squared values. The second integration unit 115 is coupled to the squaring unit 114 and accumulates the squared values to generate a total squared value. The variation unit 116 is coupled to the counting unit 111 and the second integration unit 115 and divides the total squared value by the total amount to generate a variation value, which corresponds to the standard deviation of the convolution operation results CO containing the fractional parts. The average value and the variation value represent the total scale of the convolution operation results CO containing the fractional parts, and they are outputted to the estimator 12. According to the received average value and the variation value, the estimator 12 can estimate the possible convolution operation scale based on Gaussian distribution and then generate the scaling signal S.

In the above embodiments, the convolution operation device can be a chip, and the memory can be a cache or register inside the chip. The memory can be an SRAM (static random-access memory). The scale control module 1, the scaling unit 2 and the convolution operation module 3 can be the logic circuits inside the chip.

In summary, the convolution operation device and the scaling method of the convolution inputs of the convolution neural network of this disclosure can adjust the convolution operation input values containing fractional parts according to the total scale of the convolution operation results containing fractional parts. Accordingly, during the convolution operation, the numeric is not always in the fixed point format. In this disclosure, the possible range of the subsequent or next convolution operation results is estimated followed by dynamically scaling up or down the scale of the convolution operation input values and adjusting the position of the decimal point of the convolution operation input values. This configuration can prevent the truncation error or ceiling error in the convolution operation.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A convolution operation device, comprising:
a convolution operation module outputting a plurality of convolution operation results containing fractional parts;
a memory coupled to the convolution operation module for receiving and storing the convolution operation results containing the fractional parts, and outputting a plurality of convolution operation input values containing fractional parts;
a scale control module coupled to the convolution operation module and generating a scaling signal according to a total scale of the convolution operation results containing the fractional parts; and
a scaling unit coupled to the memory, the scale control module, and the convolution operation module, adjusting a scale of the convolution operation input values containing the fractional parts according to the scaling signal, and outputting the adjusted convolution operation input values containing the fractional parts to the convolution operation module.

2. The convolution operation device according to claim 1, wherein the convolution operation results containing the fractional parts are operation results of an (N−1)^{th} layer of a convolution neural network, the convolution operation input values containing the fractional parts are operation inputs of an N^{th} layer of the convolution neural network, and N is a natural number greater than 1.

3. The convolution operation device according to claim 2, wherein the convolution operation results containing the fractional parts of a final layer of the convolution neural network stored in the memory are directly outputted without processing a reverse scaling.

4. The convolution operation device according to claim 2, wherein the convolution operation results containing the fractional parts of a final layer of the convolution neural network stored in the memory are processed with a reverse scaling and then outputted.

5. The convolution operation device according to claim 1, wherein the scale control module comprises:
a detector coupled to the convolution operation module for detecting the total scale of the convolution operation results containing the fractional parts; and
an estimator coupled to the detector for receiving at least a convolution operation coefficient and estimating a possible convolution operation scale according to the total scale of the convolution operation results containing the fractional parts and the convolution operation coefficient so as to generate the scaling signal according to the possible convolution operation scale.

6. The convolution operation device according to claim 5, wherein when the possible convolution operation scale is relative small, the scaling signal control the scaling unit to scale up the convolution operation input values containing the fractional parts.

7. The convolution operation device according to claim 5, wherein when the possible convolution operation scale is relative large, the scaling signal control the scaling unit to scale down the convolution operation input values containing the fractional parts.

8. The convolution operation device according to claim 5, wherein the detector comprises:
a counting unit accumulating amounts of the convolution operation results containing the fractional parts for outputting a total amount;
a first integration unit accumulating values of the convolution operation results containing the fractional parts for outputting a total value;
an averaging unit coupled to the counting unit and the first integration unit and dividing the total value by the total amount to generate an average value;
a squaring unit squaring the values of the convolution operation results containing the fractional parts for outputting a plurality of squared values;
a second integration unit coupled to the squaring unit and accumulating the squared values to generate a total squared value; and
a variation unit coupled to the counting unit and the second integration unit and dividing the total squared value by the total amount to generate a variation value;
wherein, the average value and the variation value represent the total scale of the convolution operation results containing the fractional parts.

9. The convolution operation device according to claim 8, wherein the estimator estimates the possible convolution operation scale according to Gaussian distribution.

10. The convolution operation device according to claim 1, wherein the convolution operation device is a chip, and the memory is a cache or a register inside the chip.

11. A scaling method of convolution inputs of a convolution neural network, comprising:
outputting a plurality of convolution operation results containing fractional parts from a convolution operation module;
generating a scaling signal according to a total scale of the convolution operation results containing the fractional parts;
outputting a plurality of convolution operation input values containing fractional parts from a memory;
adjusting a scale of the convolution operation input values containing the fractional parts according to the scaling signal; and
outputting the adjusted convolution operation input values containing the fractional parts to the convolution operation module.

12. The scaling method according to claim 11, wherein the convolution operation results containing the fractional parts are operation results of an (N−1)^{th} layer of a convolution neural network, the convolution operation input values containing the fractional parts are operation inputs of an N^{th} layer of the convolution neural network, and N is a natural number greater than 1.

13. The scaling method according to claim 12, wherein the convolution operation results containing the fractional parts of a final layer of the convolution neural network stored in the memory are directly outputted without processing a reverse scaling.

14. The scaling method according to claim 12, wherein the convolution operation results containing the fractional parts of a final layer of the convolution neural network stored in the memory are processed with a reverse scaling and then outputted.

15. The scaling method according to claim 11, wherein the step of generating the scaling signal comprises:
detecting the total scale of the convolution operation results containing the fractional parts;
estimating a possible convolution operation scale according to the total scale of the convolution operation results containing the fractional parts and a convolution operation coefficient; and
generating the scaling signal according to the possible convolution operation scale.

16. The scaling method according to claim 15, wherein when the possible convolution operation scale is relative small, the scaling signal control the scaling unit to scale up the convolution operation input values containing the fractional parts.

17. The scaling method according to claim 15, wherein when the possible convolution operation scale is relative large, the scaling signal control the scaling unit to scale down the convolution operation input values containing the fractional parts.

18. The scaling method according to claim 15, wherein the step of detecting the total scale comprises:
accumulating amounts of the convolution operation results containing the fractional parts for outputting a total amount;
accumulating values of the convolution operation results containing the fractional parts for outputting a total value;
dividing the total value by the total amount to generate an average value;
squaring the values of the convolution operation results containing the fractional parts for outputting a plurality of squared values;
accumulating the squared values to generate a total squared value; and
dividing the total squared value by the total amount to generate a variation value;
wherein, the average value and the variation value represent the total scale of the convolution operation results containing the fractional parts.

19. The scaling method according to claim 18, wherein the estimating step is to estimate the possible convolution operation scale according to Gaussian distribution.
